(19) United States
(12) Patent Application Publication
(10) Pub. No.: US 2026/0268606 A1
(43) Pub. Date: Sep. 10, 2026

(54) VIRTUAL SCENE PROCESSING METHOD AND APPARATUS, AND ELECTRONIC DEVICE AND STORAGE MEDIUM

(71) Applicant: Beijing Zitiao Network Technology Co., Ltd., Beijing (CN)

(72) Inventors: Lei ZHANG, Beijing (CN); Yuting ZHU, Beijing (CN); Yunpeng WU, Beijing (CN); Hao LIU, Beijing (CN)

(21) Appl. No.: 19/167,848

(22) PCT Filed: Mar. 13, 2024
(86) PCT No.: PCT/CN2024/081533

§ 371 Date: Sep. 23, 2025

(30) Foreign Application Priority Data
Mar. 27, 2023 (CN) 202310308965.6

(51) Int. Cl. G06T 19/00; G06F 3/04815; G06F 3/0486; H04N 21/431; H04N 21/81

(52) U.S. Cl. CPC G06T 19/00; G06F 3/04815; G06F 3/0486; H04N 21/4318; H04N 21/816

(57) ABSTRACT

Embodiments of the present disclosure provide a virtual scene processing method, apparatus, electronic device and storage medium. The method comprises: displaying a video editing interface, wherein the video editing interface comprises at least one scene capturing camera position; receiving a change trigger operation for the scene capturing camera position, and displaying a virtual scene picture corresponding to the scene capturing camera position; receiving a picture adjustment operation for the virtual scene picture, adjusting display information of a virtual scene corresponding to the virtual scene picture, and displaying the adjusted virtual scene picture; and in response to a confirmation trigger operation for the scene capturing camera position, obtaining camera parameters of a virtual camera corresponding to the displayed adjusted virtual scene picture, and associating the camera parameters with the scene capturing camera position.

### CROSS-REFERENCE TO RELATED APPLICATION(S)

This application claims priority to Chinese Application No. 202310308965.6 filed on Mar. 27, 2023 and entitled “VIRTUAL SCENE PROCESSING METHOD AND APPARATUS, AND ELECTRONIC DEVICE AND STORAGE MEDIUM”, the disclosure of which is incorporated herein by reference in its entity.

### FIELD

The present disclosure relates to the field of human-computer interaction technology, and in particular, to a virtual scene processing method, apparatus, electronic device and storage medium.

### BACKGROUND

With the continuous development of image processing technology and computer vision technology, the functionality of presenting a pre-constructed virtual scene in a display interface can be fulfilled, thus bringing about brand-new visual experience to users.

In the prior art, during the process of making a video through a virtual scene, the video is generally generated based on a picture of the virtual scene currently displayed in a video editing interface. If a user wants to change a display angle of the virtual scene in the video, the display picture of the virtual scene in the video editing interface has to be adjusted, and a video is re-generated based on the adjusted virtual scene.

However, in a video making scene, users' display requirements for virtual scenes are usually different. When faced with a requirement of the same user for multi-angle switch-display of the virtual scene, the user needs to perform complex adjustment operations, and even a display angle which has been used still needs to be adjusted according to a current display picture. As a result, the video making process takes a lot of time, the video making efficiency is reduced, and further the user experience is rather unsatisfactory.

### SUMMARY

The present disclosure provides a virtual scene processing method, apparatus, electronic device and storage medium, so as to make customized adjustment to a virtual scene picture of an original scene capturing camera position to obtain a virtual scene picture which meets user requirements under the premise of reducing the amount of data storage. Therefore, the display effect of the virtual scene picture is improved.

In a first aspect, an embodiment of the present disclosure provides a virtual scene processing method, comprising:
displaying a video editing interface, wherein the video editing interface comprises at least one scene capturing camera position;
receiving a change trigger operation for the scene capturing camera position, and displaying a virtual scene picture corresponding to the scene capturing camera position;
receiving a picture adjustment operation for the virtual scene picture, adjusting display information of a virtual scene corresponding to the virtual scene picture, and displaying the adjusted virtual scene picture; and
in response to a confirmation trigger operation for the scene capturing camera position, obtaining camera parameters of a virtual camera corresponding to the displayed adjusted virtual scene picture, and associating the camera parameters with the scene capturing camera position.

In a second aspect, an embodiment of the present disclosure further provides a virtual scene processing apparatus, comprising:
an interface display module configured to display a video editing interface, wherein the video editing interface comprises at least one scene capturing camera position;
a picture display module configured to receive a change trigger operation for the scene capturing camera position, and display a virtual scene picture corresponding to the scene capturing camera position;
a picture adjustment module configured to receive a picture adjustment operation for the virtual scene picture, adjust display information of a virtual scene corresponding to the virtual scene picture, and display the adjusted virtual scene picture; and
a camera position confirmation configured to, in response to a confirmation trigger operation for the scene capturing camera position, obtain camera parameters of a virtual camera corresponding to the displayed adjusted virtual scene picture, and associate the camera parameters with the scene capturing camera position.

In a third aspect, an embodiment of the present disclosure provides an electronic device, comprising:
one or more processors;
a storage unit configured to store one or more programs,
wherein the one or more programs, when executed by the one or more processors, cause the one or more processors to implement a virtual scene processing method of any of the embodiments of the present disclosure.

In a fourth aspect, an embodiment of the present disclosure provides a storage medium comprising computer executable instructions, wherein the computer executable instructions, when executed by a computer processor, are used for performing a virtual scene processing method of any of the embodiments of the present disclosure.

According to the technical solution of the embodiments of the present disclosure, a video editing interface is displayed, and a scene capturing camera position is displayed in the video editing interface; then, a change trigger operation for the scene capturing camera position is received, and a virtual scene picture corresponding to the scene capturing camera position is displayed; and the the scene capturing camera position is associated with the virtual scene picture. In this way, the capturing camera position of the virtual scene may be effectively stored for reuse by users, and the requirement for switching the display of the multi-angle picture of the virtual scene may be satisfied through a plurality of scene capturing camera positions. Further, a picture adjustment operation for the virtual scene picture is received, display information of a virtual scene corresponding to the virtual scene picture is adjusted, and the adjusted virtual scene picture is displayed. Finally, in response to a confirmation trigger operation for the scene capturing camera position, camera parameters of a virtual camera corresponding to the displayed adjusted virtual scene picture are obtained, and the camera parameters are associated with the scene capturing camera position. Thus, the user's adjustment of the existing scene capturing camera position can be further met, and the user's personalized demand for the display of a virtual scene in the video production process can be satisfied, solving the repetitive adjustment of the virtual scene picture corresponding to the scene capturing camera position in the prior art, as well as problems such that the display of the virtual scene picture can not meet the user's multi-directional display needs. Further, customized adjustment can be made to a virtual scene picture of an original scene capturing camera position to obtain a virtual scene picture which meets user requirements under the premise of reducing the amount of data storage, the display effect of the virtual scene picture is improved, and the user experience of application software is improved.

### BRIEF DESCRIPTION OF THE DRAWINGS

Through the following detailed implementations with reference to the accompanying drawings, the above and other features, advantages and aspects of respective embodiments of the present disclosure will become more apparent. The same or similar reference numerals represent the same or similar elements throughout the figures. It should be understood that the figures are merely schematic, and components and elements are not necessarily drawn to scale.

FIG. 1 illustrates a schematic flowchart of a virtual scene processing method according to an embodiment of the present disclosure;

FIG. 2 illustrates a schematic diagram of a video editing interface according to an embodiment of the present disclosure;

FIG. 3 illustrates a schematic flowchart of another virtual scene processing method according to an embodiment of the present disclosure;

FIG. 4 illustrates a schematic diagram of a video editing interface according to an embodiment of the present disclosure;

FIG. 5 illustrates a schematic flowchart of a further virtual scene processing method according to an embodiment of the present disclosure;

FIG. 6 illustrates a schematic flowchart of a virtual scene processing method according to an embodiment of the present disclosure;

FIG. 7 illustrates a structural schematic diagram of a virtual scene processing apparatus according to an embodiment of the present disclosure; and

FIG. 8 illustrates a structural schematic diagram of an electronic device according to an embodiment of the present disclosure.

### DETAILED DESCRIPTION OF EMBODIMENTS

The embodiments of the present disclosure will be described in more detail with reference to the accompanying drawings, in which some embodiments of the present disclosure have been illustrated. However, it should be understood that the present disclosure can be implemented in various manners, and thus should not be construed to be limited to embodiments disclosed herein. On the contrary, those embodiments are provided for the thorough and complete understanding of the present disclosure. It should be understood that the drawings and embodiments of the present disclosure are only used for illustration, rather than limiting the protection scope of the present disclosure.

It should be understood that various steps described in method implementations of the present disclosure may be performed in a different order and/or in parallel. In addition, the method implementations may comprise an additional step and/or omit a step which is shown. The scope of the present disclosure is not limited in this regard.

The term “comprise/include” and their variants used herein are to be read as open terms that mean “include, but is not limited to.” The term “based on” is to be read as “based at least in part on.” The term “one embodiment” are to be read as “at least one embodiment.” The term “another embodiment” is to be read as “at least one other embodiment.” The term “some embodiments” are to be read as “at least some embodiments.” Other definitions will be presented in the description below.

Note that the concepts “first,” “second” and so on mentioned in the present disclosure are only for differentiating different apparatuses, modules or units rather than limiting the order or mutual dependency of functions performed by these apparatuses, modules or units.

Note that the modifications “one” and “a plurality” mentioned in the present disclosure are illustrative rather than limiting, and those skilled in the art should understand that unless otherwise specified, they should be understood as “one or more.”

Names of messages or information interacted between a plurality of apparatuses in the implementations of the present disclosure are merely for the illustration purpose, rather than limiting the scope of these messages or information.

It is to be understood that, before applying the technical solutions disclosed in various embodiments of the present disclosure, the user should be informed of the type, scope of use, and use scenario of the personal information involved in the present disclosure in an appropriate manner in accordance with relevant laws and regulations, and user authorization should be obtained.

For example, in response to receiving an active request from the user, prompt information is sent to the user to explicitly inform the user that the requested operation would acquire and use the user's personal information. Therefore, according to the prompt information, the user may decide on his/her own whether to provide the personal information to the software or hardware, such as electronic devices, applications, servers, or storage media that perform operations of the technical solutions of the present disclosure.

As an optional but non-limiting implementation, in response to receiving an active request from the user, the way of sending the prompt information to the user may, for example, include a pop-up window, and the prompt information may be presented in the form of text in the pop-up window. In addition, the pop-up window may also carry a select control for the user to choose to “agree” or “disagree” to provide the personal information to the electronic device.

It is to be understood that the above process of notifying and obtaining the user authorization is only illustrative and does not limit the implementations of the present disclosure. Other methods that satisfy relevant laws and regulations are also applicable to the implementations of the present disclosure.

Meanwhile, it is to be understood that data involved in the present technical solution (including but not limited to the data itself, the acquisition or use of the data) should comply with requirements of corresponding laws and regulations and relevant rules.

Before describing the present technical solution, example illustration is first given to an application scenario, and the technical solution of the embodiments of the present disclosure is applicable to any scenario in which a virtual scene needs to be multi-camera presented. The virtual scene may be a three-dimensional virtual scene or a two-dimensional virtual scene. As an example, in order to multi-camera present the virtual scene, first of all, a plurality of capturing camera positions may be determined, virtual scene pictures of the virtual scene under different capturing camera positions may be determined, and the virtual scene picture and its corresponding capturing camera position are stored in correspondence to each other in a storage space. In this way, when presenting the virtual scene picture in a display interface, the prestored virtual scene picture may be invoked for presentation. However, the quantity of virtual scene pictures which can be stored in the storage space is limited. Meanwhile, during application, a capturing camera position predetermined by a developer might fail to meet a user requirement, so that the virtual scene picture satisfying the user requirement cannot be presented, and in turn the presentation effect of the virtual scene and the user experience are affected. In view of this, based on the solution of the embodiments of the present disclosure, a virtual scene picture corresponding to a scene capturing camera position may be adjusted based on an original scene capturing camera position, and the adjusted virtual scene picture is associated with the scene capturing camera position. Therefore, the effect of obtaining the virtual scene picture up to the user requirement can be achieved by adjusting the virtual scene picture corresponding to the original scene capturing camera position.

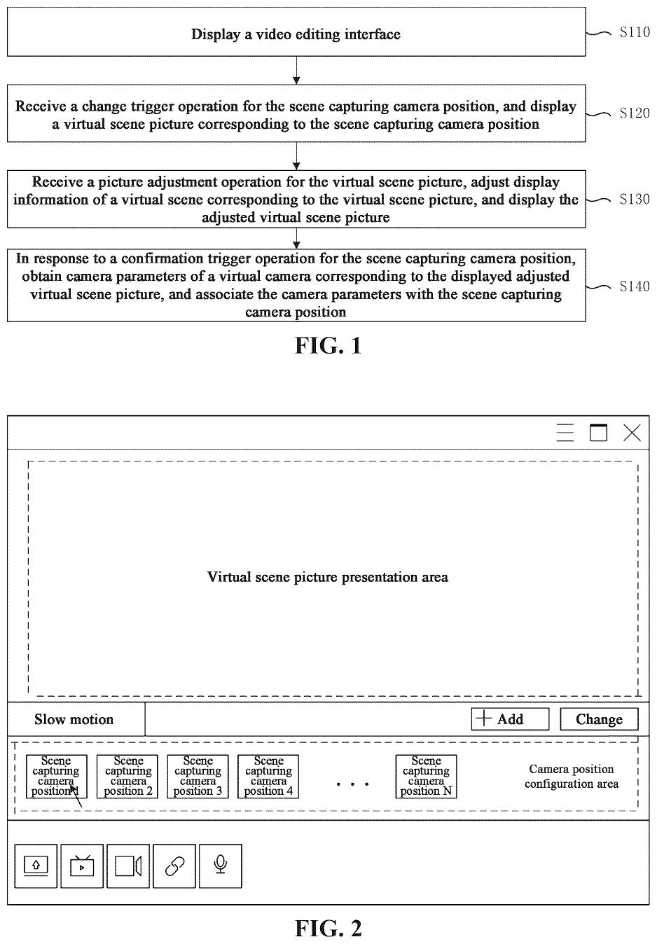

FIG. 1 is a schematic flowchart of a virtual scene processing method according to an embodiment of the present disclosure. The embodiments of the present disclosure are applicable to a situation in which the virtual scene picture of the original scene capturing camera position is adjusted on the premise of the original scene capturing camera position, so as to change the camera parameters corresponding to the scene capturing camera position based on the adjusted virtual scene picture. The method may be performed by a virtual scene processing apparatus, and the apparatus may be implemented in the form of software and/or hardware, optionally, implemented through an electronic device which may be a mobile terminal, a PC, a server and the like.

As shown in FIG. 1, the method of this embodiment may specifically comprise:
S110, displaying a video editing interface.

In this embodiment, the video editing interface may be a visualization interface for editing a video picture. In the embodiments of the present disclosure, the video editing interface may be a visualization editing interface supporting the user to make a video based on a virtual reality scene, wherein the video editing interface comprises at least one scene capturing camera position, and wherein the scene capturing camera position may correspond to a capturing parameter of a virtual camera in the virtual scene. That is, each scene capturing camera position corresponds to a video picture of the virtual scene under the same or different capturing viewing angles. The video editing interface may comprise a plurality of function areas, each of which may present corresponding display information. Optionally, the video editing interface comprises a camera position configuration area, the camera position configuration area being used for presenting the scene capturing camera position. The camera position configuration area may be any area in the video editing interface, and optionally, may be a bottom area in the video editing interface. As an example, as shown in FIG. 2, this figure is a schematic diagram of a video editing interface. As seen from FIG. 2, the video editing interface may comprise a virtual scene picture presentation area for presenting a virtual scene picture and a camera position configuration area for presenting a scene capturing camera position. The camera position configuration area may comprise scene capturing camera positions 1-N, and upon detecting a trigger operation on any of the scene capturing camera positions, a virtual scene picture corresponding to the scene capturing camera position may be displayed in the virtual scene picture presentation area.

In this embodiment, an interface display trigger operation for displaying a video editing interface may be developed in advance, so as to display a corresponding video editing interface upon detecting that the interface display trigger operation is triggered. Optionally, the interface display trigger operation may comprise at least one of: triggering an interface display control; receiving an interface display instruction; audio information comprising a wakeup word corresponding to an interface display operation.

A control for triggering the display of a video editing interface may be developed in advance. Upon detecting that the user triggers the control, the interface display trigger operation may be responded to, so that the video editing interface is displayed on the display interface. It is to be noted that the video editing interface display interface may be provided on the desktop of a terminal device or provided in a menu list, which is not limited in the embodiments of the present disclosure. As an example, a click operation for the video editing interface display control in the menu list is received, and then, the video editing interface is displayed in response to the click operation. The click operation may a single-click operation or a multi-click operation (e.g., a double-click operation, etc.).

There may be another implementation as follows: a segment of program codes for triggering the display of a video editing interface may be developed in advance, so that an interface display trigger operation may be responded to upon receiving the program codes, and the video editing interface may be displayed in the display interface.

There may be a further implementation as follows: audio information of the user may be collected in advance, and analysis processing is performed on the collected audio information so as to recognize words corresponding to the audio information; where preset wakeup words are detected in the words corresponding to the audio information, optionally, the wakeup words may be “please open a video editing interface”, “please present a video editing interface” and such types of words, and then the video editing interface may be displayed in the display interface.
S120, receiving a change trigger operation for the scene capturing camera position, and displaying a virtual scene picture corresponding to the scene capturing camera position.

In this embodiment, after displaying the video editing interface in the display interface, a change trigger operation may be input for one or more scene capturing camera positions comprised in the video editing interface, so that a virtual scene picture corresponding to the scene capturing camera position is displayed. The change trigger operation may be any trigger operation for a scene capturing camera position which needs to be changed, for example, a click operation for the scene capturing camera position comprised in the video editing interface, wherein the click operation may be a single-click operation or a multi-click operation (e.g., a double-click operation, etc.). In order to facilitate user operations, the change trigger operation for the scene capturing camera position may further be, upon detecting that a pause duration of the user for any scene capturing camera position based on an input device or a touch point reaches a preset duration, using the scene capturing camera position as a selected scene capturing camera position and displaying a virtual scene picture corresponding to the scene capturing camera position. The virtual scene picture may a picture of the virtual scene under a corresponding capturing angle.

In practical application, upon detecting a change trigger operation for a scene capturing camera position comprised in a video editing interface, a virtual scene picture corresponding to the scene capturing camera position may be determined and displayed. In this embodiment, there may be at least two modes of determining a virtual scene picture, which are described separately below.

One mode may be as follows: upon detecting a change trigger operation for any scene capturing camera position in a video editing interface, a virtual scene may be captured in real time based on a capturing parameter corresponding to the scene capturing camera position, and further a captured picture may be used as a virtual scene corresponding to the scene capturing camera position and then displayed.

Another mode may be as follows: a virtual scene may be captured in advance based on different scene capturing camera positions, so as to obtain virtual scene pictures under different scene capturing camera positions; further, the virtual scene pictures may be associated with the scene capturing camera position and stored in a storage space of the terminal device, so that upon detecting a change trigger operation for any scene capturing camera position, a corresponding virtual scene picture may be retrieved from the storage space based on the preset association relationship and then displayed.

It is to be noted that the video editing interface may comprise a virtual scene picture presentation area, which may be used for displaying a virtual scene picture. When detecting a display trigger operation on the video editing interface and displaying the video editing interface on the display interface, the virtual scene picture presentation area may display a virtual scene picture corresponding to a default scene capturing camera position, or may display a blank picture, so that upon detecting a change trigger operation for any scene capturing camera position, a picture in the virtual scene picture presentation area may be replaced as a virtual scene picture corresponding to the scene capturing camera position. In this embodiment, the default scene capturing camera position may be a scene capturing camera position preset by the developer at the development stage, or a scene capturing camera position customized by the user in the application stage. The default scene capturing camera position may be a capturing camera position corresponding to any capturing angle, and optionally, a capturing camera position corresponding to the panoramic capturing angle may be used as the default capturing camera position.

As an example, with reference to FIG. 1, when a mouse cursor (arrow in the figure) moves to scene capturing camera position 1 and inputs a click on the scene capturing camera position, the virtual scene picture corresponding to scene capturing camera position 1 is displayed in the virtual scene picture presentation area. When the mouse cursor moves to the “change” control and inputs a click on the control, the virtual scene picture in the virtual scene picture presentation area is switched to an editable state, so that the virtual scene picture corresponding to scene capturing camera position 1 may be adjusted.

In practical application, to facilitate a user to adjust a virtual scene picture and enable a user who does not understand an adjustment mode to make customized adjustment to the virtual scene picture, prompt information comprising a virtual scene picture adjustment mode may be displayed on the display interface, so that the user can adjust the virtual scene picture according to the prompt information.

Based thereon, after receiving the change trigger operation for the scene capturing camera position, the method further comprises: displaying adjustment prompt information.

The adjustment prompt information is used for prompting an operation mode for adjusting the virtual scene picture. The operation mode may be an mode for adjusting the virtual scene picture, and optionally, may comprise a drag-and-drop operation for the virtual scene picture or adjustment of the virtual scene picture based on a trigger operation of a direction adjustment control.

In practical application, after receiving a trigger operation for a scene capturing camera position, a text box may pop up in any area of the video editing interface. The text box may comprise adjustment prompt information for prompting an operation mode for adjusting the scene capturing camera position, and the user may make picture adjustment to the virtual scene picture according to the operation mode displayed in the adjustment prompt information. This setting boasts such advantages as helping the user to have a detailed understanding of the operation mode for adjusting the virtual scene picture and further improving the user experience.

It is to be noted that where the adjustment prompt information is displayed in other area than the virtual scene picture presentation area in the video editing interface, the text box comprising the adjustment prompt information may be any form of a text box, and meanwhile, a transparency of the text box may be any value; where the adjustment prompt information is displayed in a display area corresponding to the virtual scene picture in the video editing interface, the text box comprising the adjustment prompt information may be overlaid on the virtual scene picture according to a preset transparency in order to completely present the adjusted virtual scene picture and improve the adjustment presentation effect of the virtual scene picture during the picture adjustment process. Optionally, the preset transparency may be 30%, 40%, 50%, etc.
S130, receiving a picture adjustment operation for the virtual scene picture, adjusting display information of a virtual scene corresponding to the virtual scene picture, and displaying the adjusted virtual scene picture.

In this embodiment, the picture adjustment operation may be an operation for adjusting the virtual scene picture displayed in the video editing interface. Optionally, the picture adjustment operation may comprise a drag-and-drop, a click of the virtual scene picture and/or input of a picture adjustment parameter and other operations. In practical application, after displaying the virtual scene picture in a corresponding area of the video editing interface, a picture adjustment operation may be input to the virtual scene picture based on an input device or a touch point, so that the virtual scene picture may be adjusted based on the picture adjustment operation upon receiving the picture adjustment operation. It is to be noted that depending on the object to which the picture adjustment operation corresponds, the picture adjustment operation for the virtual scene picture may include at least two modes, which are described below.

In one mode, receiving the picture adjustment operation for the virtual scene picture comprises receiving a picture drag-and-drop operation on the virtual scene picture.

In this embodiment, the picture drag-and-drop operation may be an operation corresponding to dragging and dropping the virtual scene picture to move based on the input device or touch point. In practical application, the virtual scene picture may be preset as a draggable state, and a switch trigger operation for the draggable state may be preset. In this embodiment, the change trigger operation for the scene capturing camera position may be received as the switch trigger operation in a draggable state, so that the virtual scene picture may be switched as a draggable state upon receiving the change trigger operation for the scene capturing camera position. Further, when detecting a trigger operation of the user in any area in the virtual scene picture based on an input device or a touch point, the virtual scene picture may be translated or rotated in any direction according to the trigger operation, and when detecting that a pause duration of the input device or the touch point in any area of the virtual scene picture reaches a preset duration, the virtual scene picture displayed in the current video editing interface may be used as an adjusted virtual scene picture. As an example, the picture drag-and-drop operation may be inputting a right-key long-press operation to the virtual scene picture with a mouse, and then moving the mouse to drag and drop the virtual scene picture.

It is to be noted that the adjustment of the virtual scene picture according to the picture drag-and-drop operation on the virtual scene picture corresponds to an adjustment translation distance and an adjustment rotation angle which are associated with a movement distance and a rotation angle of an input device which implements the picture drag-and-drop operation.

Another mode may be receiving a control trigger operation on a preset direction adjustment control corresponding to the virtual scene picture.

In this embodiment, the direction adjustment control may be a preset control for controlling the virtual scene to move along a preset direction. In practical application, the direction adjustment control may be a control on the input device used to operate the terminal device (e.g., a key on a keyboard). Specifically, one or more preset directions along which the virtual scene is to move may be predetermined; further, each preset direction is associated with an existing control on the input device operating the terminal device, i.e., one preset direction corresponds to one existing control, so as to control the virtual scene to move along a corresponding preset direction by clicking the existing control. At this point, the existing control associated with the preset direction may be used as the direction adjustment control. As an example, wherein the input device is a keyboard, then the direction adjustment control may comprise: letter Q—horizontal down; letter W—forward; letter E—horizontal up; letter A—left; letter S—back; letter D—right. To facilitate user operations, the direction adjustment control may be a control (e.g., display control on the screen) displayed on the display interface and touched based on the input device or the touch point. Specifically, a plurality of direction adjustment controls for controlling the virtual scene to move along a preset direction may be developed in advance, and while the virtual scene picture is displayed on the video editing interface, the direction adjustment control is displayed in any area on the video editing interface, so that the user may input a touch operation to the direction adjustment control through the input device or the touch point to control the virtual scene to move along a preset direction corresponding to the direction adjustment control. For example, a click operation is input to the direction adjustment control so as to control the virtual scene to move, wherein the click operation may be a single-click operation or a multi-click operation (e.g., double-click operation, etc.).

It is to be noted that the advantage of setting a plurality of different picture adjustment operations to adjust the virtual scene picture lies in that customized adjustment may be made to the virtual scene picture according to user requirements, which enriches the operation mode for picture adjustment, enhances the fun of picture adjustment and improves the user experience.

It is to be noted that for each preset direction adjustment control, a virtual scene movement distance corresponding to a single trigger of the direction adjustment control may be predetermined, and a mapping relationship between each virtual scene movement distance and a corresponding direction adjustment control may be established, so as to, upon detecting a single trigger operation for any direction adjustment control, control the virtual scene to move along a preset direction corresponding to the direction adjustment control and for a corresponding movement distance according to the mapping relationship.

In practical application, each virtual scene picture has camera parameters of a set of virtual cameras corresponding thereto. That is, when the virtual camera captures a virtual scene according to the corresponding camera parameter, a virtual scene picture corresponding to the camera parameter may be obtained, and different camera parameters may correspond to different virtual scene pictures. Therefore, when adjusting the virtual scene picture, a camera parameter of a virtual camera corresponding to a virtual scene picture prior to the adjustment may be obtained first, and then, an adjusted virtual scene picture may be determined according to the picture adjustment operation and the camera parameter.

Optionally, adjusting the display information of the virtual scene corresponding to the virtual scene picture comprises: updating camera parameters of a virtual camera corresponding to the virtual scene picture based on the picture adjustment operation and the currently displayed virtual scene picture; and determining display information of the virtual scene based on the updated camera parameters, and determining an adjusted virtual scene picture based on the display information.

The virtual camera may be a camera which captures with a virtual scene as the center, or may be understood as a configuration file capable of performing the behavior of a real camera. The camera parameters may be parameters characterizing the camera's own attributes and/or external attributes. The camera parameters may include a camera pose and a lens parameter, i.e., out-of-camera and in-camera parameters. The camera pose may be a parameter characterizing the camera's external attribute, and may also be understood as a parameter of the camera in a virtual coordinate system, for example, a spatial position and a rotation direction of the camera and the like; the lens parameter may be a parameter characterizing the camera's own attribute. Optionally, the lens parameter comprises at least one of a focal length parameter, a frame parameter, and an aperture parameter. Those skilled in the art should understand that the focal length parameter refers to a distance from a rear main point of the lens optics to the focal point, and the size of the focal length determines the image size, field of view, depth of field, and angle of view of the picture; the frame parameter refers to the size of the camera film; the aperture parameter refers to the numerical value characterizing the size of the camera's aperture, and the size of the aperture may be adjusted by controlling the aperture parameter, thus controlling the amount of exposure into the camera.

In this embodiment, the virtual scene is a digital scene built by developers during the development stage based on computer vision technology. The virtual scene may comprise one or more scene elements which may be constructed based on a three-dimensional model. It is to be noted that the virtual scene may be set based on product requirements or user requirements. The display information may be information which the virtual scene displays on the display interface, i.e., information corresponding to observation of the virtual scene based on the user's perspective.

In practical application, currently displayed camera parameters of a virtual camera corresponding to a currently displayed virtual scene picture prior to the adjustment may be obtained first, and then, upon receiving a picture adjustment operation for the virtual scene picture, the obtained camera parameters may be updated according to the picture adjustment operation, and further, the virtual scene is captured according to the updated camera parameters to obtain display information of the virtual scene under the camera parameters and determine the adjusted virtual scene picture according to the display information. The advantage of such setting lies in that by adjusting the virtual scene picture, camera parameters corresponding to the original scene capturing camera position may be updated, which increases the adjustment efficiency of the virtual scene picture and ensures the display effect of the adjusted virtual scene picture.
S140, in response to a confirmation trigger operation for the scene capturing camera position, obtaining camera parameters of a virtual camera corresponding to the displayed adjusted virtual scene picture, and associating the camera parameters with the scene capturing camera position.

In this embodiment, the confirmation trigger operation may be used for confirming the adjustment of the virtual scene picture corresponding to the scene capturing camera position. In practical application, an adjustment confirmation control may be developed in advance, or a segment of program codes for trigger confirmation may be preset. When detecting the user triggering the control or receiving the program codes, the conformation trigger operation may be responded to, thereby obtaining the camera parameters of the virtual camera corresponding to the displayed adjusted virtual scene picture.

In practical application, when detecting a confirmation trigger operation for a scene capturing camera position, a virtual scene may be captured based on a virtual camera according to the currently displayed virtual scene picture, and camera parameters of the virtual scene picture may be obtained. Further, camera parameters associated with the scene capturing camera position may be updated according to the camera parameters, i.e., camera parameters corresponding to the virtual scene picture prior to the adjustment may be overwritten based on camera parameters corresponding to the adjusted virtual scene picture, so that the camera parameters corresponding to the adjusted virtual scene picture may be associated with the scene capturing camera position. Therefore, when detecting a trigger operation for the scene capturing camera position, display information of the virtual scene may be determined according to the updated camera parameters, and further, the virtual scene picture corresponding to the scene capturing camera position may be determined based on the display information.

According to the technical solution of the embodiments of the present disclosure, a video editing interface is displayed, and a scene capturing camera position is displayed in the video editing interface; then, a change trigger operation for the scene capturing camera position is received, and a virtual scene picture corresponding to the scene capturing camera position is displayed; and the scene capturing camera position is associated with the virtual scene picture. In this way, the capturing camera position of the virtual scene may be effectively stored for reuse by users, and the requirement for switching the display of the multi-angle picture of the virtual scene may be satisfied through a plurality of scene capturing camera positions. Further, a picture adjustment operation for the virtual scene picture is received, display information of a virtual scene corresponding to the virtual scene picture is adjusted, and the adjusted virtual scene picture is displayed. Finally, in response to a confirmation trigger operation for the scene capturing camera position, camera parameters of a virtual camera corresponding to the displayed adjusted virtual scene picture are obtained, and the camera parameters are associated with the scene capturing camera position. Thus, the user's adjustment of the existing scene capturing camera position can be further met, and the user's personalized demand for the display of a virtual scene in the video production process can be satisfied, solving the repetitive adjustment of the virtual scene picture corresponding to the scene capturing camera position in the prior art, as well as problems such that the display of the virtual scene picture cannot meet the user's multi-directional display needs. Further, customized adjustment can be made to a virtual scene picture of an original scene capturing camera position to obtain a virtual scene picture which meets user requirements under the premise of reducing the amount of data storage, the display effect of the virtual scene picture is improved, and the user experience of application software is improved.

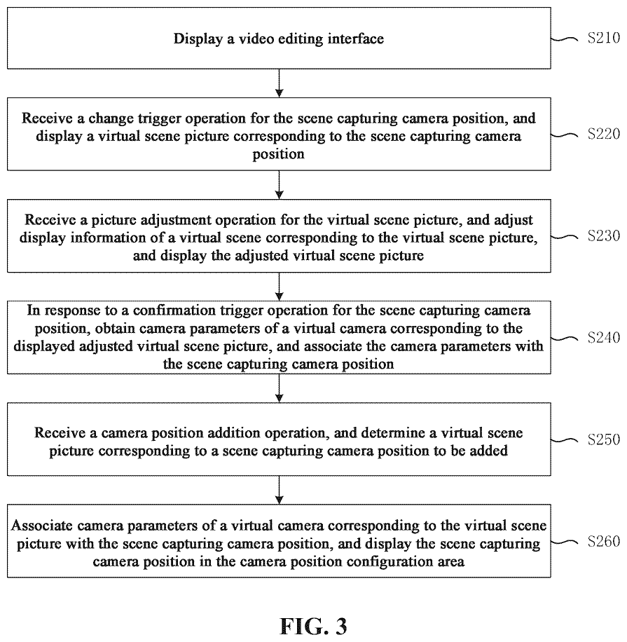

FIG. 3 is a schematic flowchart of another virtual scene processing method according to an embodiment of the present disclosure. Based on the foregoing embodiments, the technical solution of this embodiment may further comprise: receiving a camera position addition operation, determining a virtual scene picture corresponding to a scene capturing camera position to be added, associating camera parameters of a virtual camera corresponding to the virtual scene picture with the scene capturing camera position, and displaying the scene capturing camera position in the camera position configuration area. A specific implementation may refer to the description of this embodiment, wherein technical solutions which are the same as or similar to those of the foregoing embodiments are not repeated herein.

As shown in FIG. 3, the method of this embodiment may specifically comprise:
S210, displaying a video editing interface;
S220, receiving a change trigger operation for the scene capturing camera position, and displaying a virtual scene picture corresponding to the scene capturing camera position;
S230, receiving a picture adjustment operation for the virtual scene picture, adjusting display information of a virtual scene corresponding to the virtual scene picture, and displaying the adjusted virtual scene picture;
S240, in response to a confirmation trigger operation for the scene capturing camera position, obtaining camera parameters of a virtual camera corresponding to the displayed adjusted virtual scene picture, and associating the camera parameters with the scene capturing camera position;
S250, receiving a camera position addition operation, and determining a virtual scene picture corresponding to a scene capturing camera position to be added.

In this embodiment, the camera position addition operation may be an operation corresponding to the addition of a new scene capturing camera position based on an original scene capturing camera position. In practical application, a camera position addition control may be developed in advance, and when detecting a trigger operation of the user for the control, it may be determined that a camera position addition operation is triggered. Optionally, the camera position addition control may be a display control displayed in any area of the video editing interface, and when detecting a trigger operation for the display control, it is determined that a camera position addition operation is triggered; or the camera position addition control may be a display control displayed in a function menu. Specifically, a click operation for any area in the video editing interface may be input, and further, in response to the click operation, a function menu is presented in the area, the function menu comprising one or more display controls characterizing different functions. When detecting a trigger operation on the camera position addition control in the function menu, it is determined that a camera position addition operation is triggered.

The scene capturing camera position to be added may be a capturing camera position to be added to the video editing interface, and meanwhile, the capturing camera position is distinguished from a scene capturing camera position displayed in the video editing interface.

In practical application, besides the existing scene capturing camera position in the video editing interface, the user may further add one or more scene capturing camera positions in the video editing interface according to their own needs. Specifically, when detecting a camera position addition operation, a scene capturing camera position to be added may be determined according to the camera position addition operation, and further, a virtual scene picture corresponding to the scene capturing camera position to be added may be determined.

It is to be noted that depending on the object to which the camera position addition operation corresponds, the virtual scene picture corresponding to the scene capturing camera position to be added may correspond to at least two determination modes, which are described below.

In one mode, receiving the camera position addition operation and determining the virtual scene picture corresponding to the scene capturing camera position to be added comprises: receiving a camera position addition operation, and displaying, in the camera position configuration area, a scene capturing camera position to be added; and in response to a picture confirmation operation input for the scene capturing camera position, using a confirmed virtual scene picture as the virtual scene picture corresponding to the scene capturing camera position.

In this embodiment, a picture confirmation control may be developed in advance and displayed in any area of the video editing interface, or any key of an input device for controlling the operation of the terminal device is associated with a picture confirmation function in advance, so that when detecting the trigger of the user for the picture confirmation control or detecting a key on the input device for characterizing the picture confirmation function, it may be determined that a picture confirmation operation is triggered.

In practical application, when detecting that the user triggers the camera position addition operation, a scene capturing camera position to be added may be displayed in the camera position configuration area, at which point a virtual scene picture corresponding to the scene capturing camera position is a blank picture. While the scene capturing camera position to be added is displayed in the camera position configuration area, the virtual scene picture displayed in the video editing interface may be switched to an editable state, and the user may input a picture adjustment operation to the virtual scene picture through the input device or the touch point so as to adjust display information of a virtual scene corresponding to the virtual scene picture and display the adjusted virtual scene picture. Further, after the virtual scene picture is determined, a picture confirmation operation may be input for the scene capturing camera position, at which point the confirmed virtual scene picture displayed in the display interface may be used as the virtual scene picture corresponding to the scene capturing camera position. The advantage of such setting lies in enhancing the fun of the camera position addition process and increasing the flexibility of adjustment of the virtual scene picture corresponding to the scene capturing camera position to be added in the process of modifying the scene capturing camera position, so that the added scene capturing camera position can better meet customized requirements of users.

In another mode, receiving the camera position addition operation and determining the virtual scene picture corresponding to the scene capturing camera position to be added comprises: receiving a camera position addition operation on the virtual scene picture, and determining the virtual scene picture as a virtual scene picture corresponding to a scene capturing camera position to be added.

In practical application, when the virtual scene picture is in an editable state, the user may directly adjust the virtual scene picture displayed in the video editing interface, specifically, may input a picture adjustment operation to the virtual scene picture through the input device or the touch point to adjust the virtual scene picture. During adjustment, the user may determine whether the virtual scene picture adjusted currently meets a camera position addition requirement depending on the virtual scene picture displayed in the video editing interface; when detecting a camera position addition operation for the virtual scene picture, the virtual scene picture displayed in the video editing interface at a current point of time may be used as a virtual scene picture corresponding to a scene capturing camera position to be added. In other words, when triggering a camera position addition operation, camera parameters of the virtual scene picture displayed in the video editing interface may be crawled, and a scene capturing camera position corresponding to the virtual scene picture may be generated. The advantage of such setting lies in that a scene capturing camera position may be easily and rapidly generated according to the virtual scene picture displayed in the video editing interface, which simplifies operation steps of the camera position addition operation, increases the efficiency of camera position addition and improves the user experience.

As an example, a given scene capturing camera position may be selected in advance, a virtual scene picture corresponding to the scene capturing camera position may be displayed, and further, the virtual scene picture is adjusted to obtain an adjusted display picture. When receiving a trigger of the camera position addition operation, a scene capturing camera position is directly generated based on the currently displayed virtual scene picture. The advantage of such setting lies in that adjustment may be made by selecting a virtual display screen similar to the camera parameters of the virtual display picture of the scene capturing camera position to be added as a starting picture, thereby saving the time of the adjustment of the virtual display picture and increasing the generation efficiency of the scene capturing camera position.

It is to be noted that when determining a virtual scene picture corresponding to a scene capturing camera position to be added, a camera position name of the scene capturing camera position to be added may be subjected to customized edition, so that the camera position name may be displayed in associated with the scene capturing camera position when displaying the scene capturing camera position in the camera position configuration area.
S260, associating camera parameters of a virtual camera corresponding to the virtual scene picture with the scene capturing camera position, and displaying the scene capturing camera position in the camera position configuration area.

In practical application, after the virtual scene picture corresponding to the scene capturing camera position to be added is determined, camera parameters of a virtual camera in capturing a virtual scene and obtaining the virtual scene picture may be determined according to the virtual scene picture. Afterwards, the camera parameters may be written to configuration parameters corresponding to the scene capturing camera position so as to establish an association relationship between the camera parameters and the scene capturing camera position. Meanwhile, the scene capturing camera position may be displayed in the camera position configuration area, and while displayed in the camera position configuration area, identification information corresponding to the scene capturing camera position may be displayed. Optionally, the identification information may comprise a thumbnail of the virtual scene picture and/or text identification corresponding to the scene capturing camera position, etc.

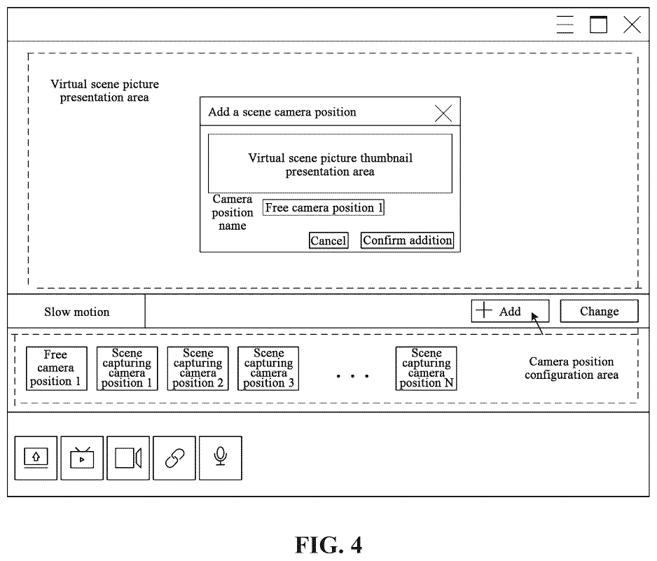

As an example, as shown in FIG. 4, the virtual scene picture presented in the virtual scene picture presentation area may be a virtual scene picture corresponding to a scene capturing camera position to be added. When the mouse cursor (arrow in the figure) moves to a “+add” control and inputs a click operation for the control, a text box (small rectangular box in the figure) “add a capturing camera position” may pop up, and the text box may comprise a thumbnail of the virtual scene picture, a camera position name editing control, a “cancel” control and a “confirm addition” control. The user may edit a camera position name in the camera position name editing control, e.g., “free camera position 1”. Further, when the mouse cursor moves to the “confirm addition” control and inputs a click operation for the control, free camera position 1 and the thumbnail of the corresponding virtual scene picture may be displayed in the camera position configuration area.

In practical application, a camera position deletion operation may further be received besides the camera position addition operation. Specifically, when receiving a camera position deletion operation, a virtual scene picture corresponding to a scene capturing camera position to be deleted and camera parameters of a virtual camera corresponding to the virtual scene picture may be deleted from a local storage space. The advantage of such setting lies in that the data storage amount of application software may be reduced, and further, the response rate of application software may be increased, which improves the user experience.

It is to be noted that the camera position addition operation in step S250 and the change trigger operation in step S220 are two independent operations in the video editing scenario, and there is no order of precedence between these two operations. That is, the camera position addition operation may be performed in any scenario of scene capturing, for example, may be performed in a scenario before adjusting the scene capturing camera position. That is, the camera position addition operation may be performed before receiving the change trigger operation for the scene capturing camera position, or may be performed in a scenario after adjusting any scene capturing camera position, i.e., may be performed after displaying the scene capturing camera position in the camera position configuration area. The embodiments of the present disclosure are not intended to make any limitation in this regard.

According to the technical solution of the embodiments of the present disclosure, a video editing interface is displayed, and then a change trigger operation for a scene capturing camera position is received, and a virtual scene picture corresponding to the scene capturing camera position is displayed; afterwards, a picture adjustment operation for the virtual scene picture is received, display information of a virtual scene corresponding to the virtual scene picture is adjusted, and an adjusted virtual scene picture is displayed; further, in response to a confirmation trigger operation for the scene capturing camera position, camera parameters of a virtual camera corresponding to the displayed adjusted virtual scene picture are obtained and associated with the scene capturing camera position; a camera position addition operation is received, and a virtual scene picture corresponding to a scene capturing camera position to be added is determined; finally, camera parameters of a virtual camera corresponding to the virtual scene picture are associated with the scene capturing camera position, and the scene capturing camera position is displayed in the camera position configuration area. In this way, the effect of customized configuration and addition of a scene capturing camera position based on user requirements is achieved, customized requirements of the user is satisfied, and the representation effect of the virtual scene and the user experience of application software are improved.

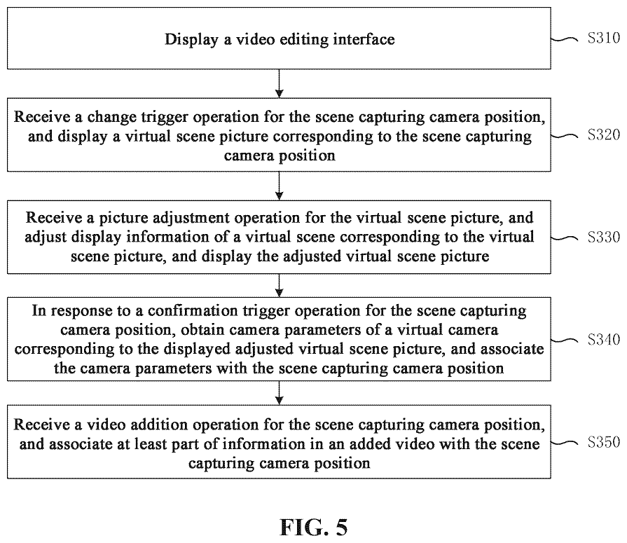

FIG. 5 is a schematic flowchart of another virtual scene processing method according to an embodiment of the present disclosure. Based on the foregoing embodiments, optionally, the technical solution of this embodiment further comprises: receiving a video addition operation for the scene capturing camera position, and associating at least part of information in an added video with the scene capturing camera position. A specific implementation may refer to the description of this embodiment, wherein technical features which are the same as or similar to those of the foregoing embodiments are not repeated herein.

As shown in FIG. 5, the method of this embodiment may specifically comprise:
S310, displaying a video editing interface;
S320, receiving a change trigger operation for the scene capturing camera position, and displaying a virtual scene picture corresponding to the scene capturing camera position;
S330, receiving a picture adjustment operation for the virtual scene picture, adjusting display information of a virtual scene corresponding to the virtual scene picture, and displaying the adjusted virtual scene picture;
S340, in response to a confirmation trigger operation for the scene capturing camera position, obtaining camera parameters of a virtual camera corresponding to the displayed adjusted virtual scene picture, and associating the camera parameters with the scene capturing camera position;
S350, receiving a video addition operation for the scene capturing camera position, and associating at least part of information in an added video with the scene capturing camera position.

In this embodiment, the video addition operation may be used for adding part of information in a video in the virtual scene picture. In practical application, a video addition control may be developed in advance; when detecting a trigger operation for the control, it may be determined that a video addition operation is triggered, and thus a video to be added to the virtual scene picture is determined. The video may be added based on a video (e.g., a live streaming video) captured by the terminal device in real time, or may be a video prestored in the storage space. Optionally, the at least part of information in the video may be audio information in the video, any main object information in the video, or all video information, etc. As an example, any main object information may comprise a dynamic main object, such as a person or an animal; and/or a static main object, such as a plant or a building, etc.

In practical application, for one or more scene capturing camera positions displayed in the camera position configuration area, first of all, a selection trigger operation may be input for a scene capturing camera position; then, a scene configuration page corresponding to the scene capturing camera position may be presented in any area in the video editing interface; further, a video addition operation for the scene capturing camera position may be input in the scene configuration page. Specifically, a click operation may be input for a video addition control displayed in the scene configuration page. At this point, a video list to be added may be presented in the scene configuration page, and the list may comprise one or more videos to be added. The user may select among the videos to be added through a trigger operation. When detecting a trigger operation of the user for any video to be added, the video to be added may be used as a video to be added corresponding to the scene capturing camera position. Further, at least part of information in the video which may be added to the virtual scene picture may be determined based on user requirements and then obtained, and the obtained at least part of information of the video may be updated to a configuration parameter corresponding to the scene capturing camera position, so as to be associated with the scene capturing camera position. In this way, when detecting a trigger operation for the scene capturing camera position, the at least part of information of the added video may further be displayed while displaying the corresponding virtual scene picture. The advantage of such setting lies in that the fusion of the virtual scene picture and video information captured in the real world is achieved, so that a combination of virtual and real scene pictures may be obtained.

It is to be noted that the same scene capturing camera position may be associated with one added video or a plurality of added videos. The embodiments of the present disclosure are not intended to limit the quantity of videos associated with the scene capturing camera position.

It is further noteworthy that at least part of information of the same video may be associated with one scene capturing camera position or a plurality of scene capturing camera positions. The embodiments of the present disclosure are not intended to limit the quantity of scene capturing camera positions associated with the video.

It is to be noted that the video addition operation in step S350 may be performed before step 320. Where the video addition operation in step S350 is performed before step 320, the scene capturing camera position associated with the at least part of information in the added video is the scene capturing camera position before the change, and further, the virtual scene picture in the finally obtained video picture is the virtual scene picture before the adjustment. Where the video addition operation in step S350 is performed after step 320, the scene capturing camera position associated with the at least part of information in the added video is the scene capturing camera position after the change, and further, the virtual scene picture in the finally obtained video picture is the virtual scene picture after the adjustment.

According to the technical solution of the embodiments of the present disclosure, a video editing interface is displayed; then, a change trigger operation for a scene capturing camera position is received, and a virtual scene picture corresponding to the scene capturing camera position is displayed; afterwards, a picture adjustment operation for the virtual scene picture is received, display information of a virtual scene corresponding to the virtual scene picture is adjusted, and an adjusted virtual scene picture is displayed; further, in response to a confirmation trigger operation for the scene capturing camera position, camera parameters of a virtual camera corresponding to the displayed adjusted virtual scene picture are obtained and associated with the scene capturing camera position; a video addition operation for the scene capturing camera position is received, and at least part of information in a video to be added is associated with the scene capturing camera position. In this way, the effect of fusing the virtual scene picture with video information captured in the real world is achieved, so that a combination of virtual and real scene pictures may be obtained, and the presentation effect of the virtual scene picture may be improved.

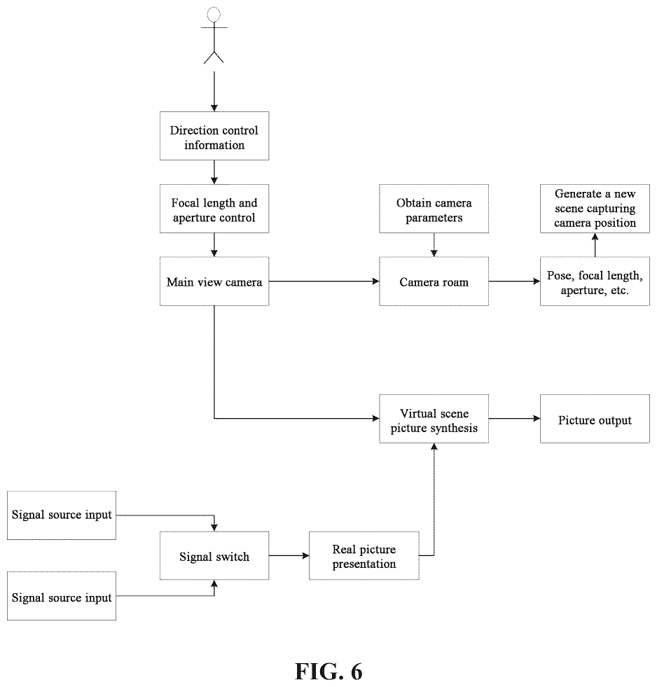

FIG. 6 is a schematic flowchart of a virtual scene processing method according to an embodiment of the present disclosure. This embodiment is an optional embodiment of the foregoing respective embodiments, with a scene capturing camera position being the main view camera for example. Specifically, the method of this embodiment may comprise the following steps:
1. receiving a change trigger operation for a scene capturing camera position, and determining a main view camera;
2. receiving a picture adjustment operation for a virtual scene picture corresponding to the main view camera, and updating camera parameters (focal length, aperture) of the main view camera according to the picture adjustment operation so as to obtain an adjusted virtual scene picture;
3. receiving a camera position addition operation, and determining, in a camera roaming state, a virtual scene picture of a scene capturing camera position to be added;
4. determining corresponding camera parameters (pose, focal length, aperture, etc.) according to the virtual scene picture;
5. associating the camera parameters with the scene capturing camera position to be added, and generating a new scene capturing camera position;
6. inputting a signal source to be added;
7. receiving a video addition operation for the main view camera, and determining the signal source to be added from a pre-input signal source according to a signal switching operation; and
8. synthesizing a real picture in the signal source to be added and the virtual scene picture corresponding to the main view camera and presenting the virtual scene picture and the real picture.

According to the technical solution of the embodiments of the present disclosure, a video editing interface is displayed; then, a change trigger operation for a scene capturing camera position is received, and a virtual scene picture corresponding to the scene capturing camera position is displayed; afterwards, a picture adjustment operation for the virtual scene picture is received, display information of a virtual scene corresponding to the virtual scene picture is adjusted, and an adjusted virtual scene picture is displayed; finally, in response to a confirmation trigger operation for the scene capturing camera position, camera parameters of a virtual camera corresponding to the displayed adjusted virtual scene picture are obtained and associated with the scene capturing camera position. In this way, such problems in the prior art are solved that the virtual scene picture corresponding to the capturing camera position is fixed and cannot be adjusted and further the virtual scene picture fails to meet user requirements. Thus, under the premise of reducing the data storage amount, customized adjustment may be made to a virtual scene picture of an existing scene capturing camera position so as to obtain a virtual scene picture which is up to user requirements, the display effect of the virtual scene picture is improved, and the user experience of application software is further improved.

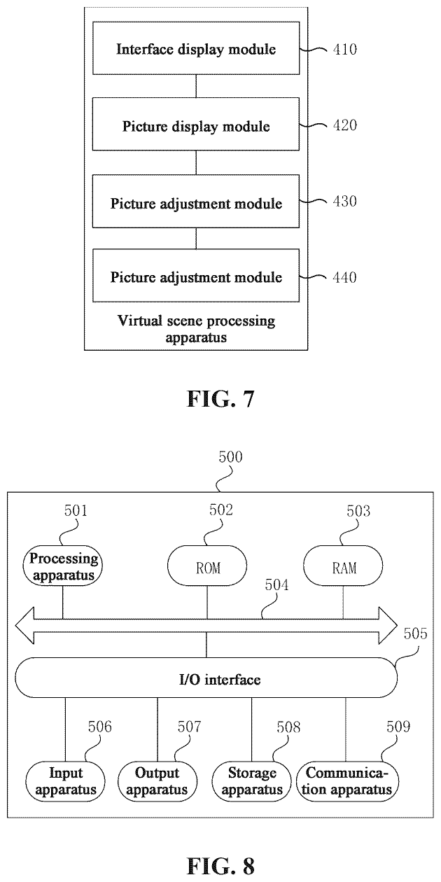

FIG. 7 is a structural schematic diagram of a virtual scene processing apparatus according to an embodiment of the present disclosure. As shown in FIG. 7, the apparatus comprises: an interface display module 410, a picture display module 420, a picture adjustment module 430 and a camera position confirmation module 440.
the interface display module 410 configured to display a video editing interface, wherein the video editing interface comprises at least one scene capturing camera position;
the picture display module 420 configured to receive a change trigger operation for the scene capturing camera position, and display a virtual scene picture corresponding to the scene capturing camera position;
the picture adjustment module 430 configured to receive a picture adjustment operation for the virtual scene picture, adjust display information of a virtual scene corresponding to the virtual scene picture, and display the adjusted virtual scene picture; and
the camera position confirmation module 440 configured to, in response to a confirmation trigger operation for the scene capturing camera position, obtain camera parameters of a virtual camera corresponding to the displayed adjusted virtual scene picture, and associate the camera parameters with the scene capturing camera position.

Based on the foregoing respective technical solutions, the picture adjustment module 430 comprises: a picture adjustment first unit and a picture adjustment second unit;
the picture adjustment first unit configured to receive a picture drag-and-drop operation on the virtual scene picture; and/or
the picture adjustment second unit configured to receive a control trigger operation on a preset direction adjustment control corresponding to the virtual scene picture, wherein the direction adjustment control is used for controlling the virtual scene to move along a preset direction.

Based on the foregoing respective technical solutions, the apparatus further comprises: a prompt information display module;
the prompt information display module configured to, after receiving the change trigger operation for the scene capturing camera position, display adjustment prompt information, wherein the adjustment prompt information is used for prompting an operation mode for adjusting the virtual scene picture.

Based on the foregoing respective technical solutions, the video editing interface comprises a camera position configuration area, the camera position configuration area being used for displaying the scene capturing camera position; accordingly, the apparatus further comprises: a virtual scene picture determining module and a scene capturing camera position display module;
the virtual scene picture determining module configured to receive a camera position addition operation, and determine a virtual scene picture corresponding to a scene capturing camera position to be added;
the camera parameter associating module configured to associate camera parameters of a virtual camera corresponding to the virtual scene picture with the scene capturing camera position, and display the scene capturing camera position in the camera position configuration area.

Based on the foregoing respective technical solutions, the virtual scene picture determining module comprises: a scene capturing camera position display unit and a virtual scene picture first determining unit;
the scene capturing camera position display unit configured to receive a camera position addition operation, and display, in the camera position configuration area, a scene capturing camera position to be added; and
the virtual scene picture first determining unit configured to, in response to a picture confirmation operation input for the scene capturing camera position, use a confirmed virtual scene picture as the virtual scene picture corresponding to the scene capturing camera position.

Based on the foregoing respective technical solutions, the virtual scene picture determining module further comprises: a virtual scene picture second determining unit;
the virtual scene picture second determining unit configured to receive a camera position addition operation on the virtual scene picture, and determine the virtual scene picture as a virtual scene picture corresponding to a scene capturing camera position to be added.

Based on the foregoing respective technical solutions, the apparatus further comprises: an information associating module;
the information associating module configured to receive a video addition operation for the scene capturing camera position, and associate at least part of information in an added video with the scene capturing camera position.

Based on the foregoing respective technical solutions, the picture adjustment module 430 further comprises: a camera parameter update unit and a display information determining unit;
the camera parameter update unit configured to update camera parameters of a virtual camera corresponding to the virtual scene picture based on the picture adjustment operation and the currently displayed virtual scene picture; and
the display information determining unit configured to determine display information of the virtual scene based on the updated camera parameters, and determine an adjusted virtual scene picture based on the display information.

Based on the foregoing respective technical solutions, the camera parameters comprise a camera pose and a lens parameter, the lens parameter comprising at least one of a focal length parameter, a frame parameter, and an aperture parameter.

According to the technical solution of the embodiments of the present disclosure, a video editing interface is displayed, and a scene capturing camera position is displayed in the video editing interface; then, a change trigger operation for the scene capturing camera position is received, and a virtual scene picture corresponding to the scene capturing camera position is displayed; and the the scene capturing camera position is associated with the virtual scene picture. In this way, the capturing camera position of the virtual scene may be effectively stored for reuse by users, and the requirement for switching the display of the multi-angle picture of the virtual scene may be satisfied through a plurality of scene capturing camera positions. Further, a picture adjustment operation for the virtual scene picture is received, display information of a virtual scene corresponding to the virtual scene picture is adjusted, and the adjusted virtual scene picture is displayed. Finally, in response to a confirmation trigger operation for the scene capturing camera position, camera parameters of a virtual camera corresponding to the displayed adjusted virtual scene picture are obtained, and the camera parameters are associated with the scene capturing camera position. Thus, the user's adjustment of the existing scene capturing camera position can be further met, and the user's personalized demand for the display of a virtual scene in the video production process can be satisfied, solving the repetitive adjustment of the virtual scene picture corresponding to the scene capturing camera position in the prior art, as well as problems such that the display of the virtual scene picture cannot meet the user's multi-directional display needs. Further, customized adjustment can be made to a virtual scene picture of an existing scene capturing camera position to obtain a virtual scene picture which meets user requirements under the premise of reducing the amount of data storage, the display effect of the virtual scene picture is improved, and the user experience of application software is improved.

The virtual scene processing apparatus provided by the embodiments of the present disclosure can perform the virtual scene processing method provided by any embodiment of the present disclosure, which includes corresponding functional modules for performing the method and has the advantageous effects.

It is to be noted that respective units and modules comprised in the foregoing apparatus are merely divided according to functional logic, but are not limited to such division, so long as corresponding functions can be performed. In addition, specific names of the respective functional units are merely for mutual differentiation and are not intended to limit the protection scope of the embodiments of the present disclosure.

FIG. 8 is a structural schematic diagram of an electronic device provided by an embodiment of the present disclosure. With reference to FIG. 8 below, this figure shows a structural schematic diagram of an electronic device 500 (e.g., a terminal device or server in FIG. 8) which is applicable to implement the embodiments of the present disclosure. The terminal device in the embodiment of the present disclosure may include, but is not limited to, a mobile terminal such as a mobile phone, a notebook computer, a digital broadcast receiver, a PDA (personal digital assistant), a PAD (portable Android device), a PMP (portable multimedia player), an on-board terminal (e.g., an on-board navigation terminal), a wearable terminal device and the like, and a fixed terminal such as digital TV, a desktop computer and the like. The electronic device shown in FIG. 8 is merely an example and should not be construed as bringing any restriction on the functionality and usage scope of the embodiments of the present disclosure.

As shown in FIG. 8, the electronic device 500 may comprise a processing apparatus (e.g., a central processor, a graphics processor) 501 which is capable of performing various appropriate actions and processes as described in the embodiments of the present disclosure in accordance with programs stored in a read only memory (ROM) 502 or programs loaded from a storage apparatus 508 to a random access memory (RAM) 703. In the RAM 503, there are also stored various programs and data required by the electronic device 500 when operating. The processing apparatus 501, the ROM 502 and the RAM 503 are connected to one another via a bus 504. An input/output (I/O) interface 505 is also connected to the bus 504.

Typically, the following units may be connected to the I/O interface 505: an input apparatus 506 including, for example, a touchscreen, a touch pad, a keyboard, a mouse, a camera, a microphone, an accelerometer, a gyroscope and the like; an output apparatus 507 including, for example, a Liquid Crystal Display (LCD), a loudspeaker, a vibrator and the like; a storage apparatus 508 including, for example, a tape, a hard drive and the like; and a communication apparatus 509. The communication apparatus 509 can allow wireless or wired communication of the electronic device 500 with other devices to exchange data. Although FIG. 8 shows the terminal device 500 with various apparatuses, it should be understood that it is not required to implement or have all of the illustrated apparatuses. Alternatively, more or less apparatuses may be implemented or exist.

In particular, according to embodiments of the present disclosure, the processes described above with reference to the flowcharts may be implemented as computer software programs. For example, embodiments of the present disclosure include a computer program product comprising a computer program carried on a non-transitory computer readable medium, the computer program containing program code for performing the methods as in the flowcharts. In those embodiments, the computer program may be downloaded and installed from a network via the communication apparatus 509, or may be installed from the storage apparatus 508, or may be installed from the ROM 502. The computer program, when executed by the processing apparatus 501, performs the above-described functions defined in the virtual resource processing method according to the embodiments of the present disclosure.

Names of messages or information interacted between a plurality of apparatuses in the implementations of the present disclosure are merely for illustration purposes, rather than limiting the scope of these messages or information.

The electronic device provided in this embodiment of the present disclosure and the virtual scene processing method provided in the foregoing embodiments belong to the same inventive concept, technical details which are not described in this embodiment may refer to the foregoing embodiments, and this embodiment has the same advantageous effect as the foregoing embodiments.

An embodiment of the present disclosure provides a computer storage medium, storing a computer program thereon, wherein the program, when executed by a processor, implements a virtual scene processing method provided in the foregoing embodiments.

It is to be noted that the computer readable medium according to the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, an RAM, an ROM, an erasable programmable read-only memory (EPROM or flash memory), an optical fiber, a portable compact disc read-only memory (CD-ROM), an optical storage device, a magnetic storage device, or any suitable combination of the foregoing. In the present disclosure, a computer readable storage medium may be any tangible medium that can contain, or store, a program for use by or in connection with an instruction execution system, apparatus, or device. In contrast, in the present disclosure, a computer readable signal medium may include a propagated data signal with computer readable program code embodied therein, either in baseband or as part of a carrier wave. Such propagated data signal may take many forms, including, but not limited to, an electro-magnetic signal, an optical signal, or any suitable combination thereof. A computer readable signal medium may also be any computer readable medium that is not a computer readable storage medium and that can communicate, propagate, or transmit a program for use by or in connection with an instruction execution system, apparatus, or device. Program code embodied on a computer readable medium may be transmitted using any appropriate medium, including but not limited to: electrical wires, optical cables, RF (radio frequency), etc., or any suitable combination of the foregoing.

In some implementations, the client and the server may perform communication by using any known network protocol such as Hyper Text Transfer Protocol (HTTP) or any network protocol to be developed, and may connect with digital data in any form or carried in any medium (for example, a communication network). The communication network includes a local area network (LAN), a wide area network (WAN), an international network (for example, the internet), a peer-to-peer network (e.g. ad hoc peer-to-peer network), and any known network or network to be developed.

The computer readable medium may be the one included in the electronic device, or may be provided separately, rather than assembled in the electronic device.

The computer readable medium carries one or more programs which, when executed by the electronic device, cause the electronic device to: display a video editing interface, wherein the video editing interface comprises at least one scene capturing camera position;
receive a change trigger operation for the scene capturing camera position, and displaying a virtual scene picture corresponding to the scene capturing camera position;
receive a picture adjustment operation for the virtual scene picture, adjust display information of a virtual scene corresponding to the virtual scene picture, and display the adjusted virtual scene picture; and
in response to a confirmation trigger operation for the scene capturing camera position, obtain camera parameters of a virtual camera corresponding to the displayed adjusted virtual scene picture, and associate the camera parameters with the scene capturing camera position.

Computer program codes for carrying out operations of the present disclosure may be written in one or more programming languages, including without limitation to, an object oriented programming language such as Java, Smalltalk, C++ or the like, and conventional procedural programming languages, such as the “C” programming language or similar programming languages. The program codes may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The units described in the embodiments of the present disclosure may be implemented as software or hardware, wherein the name of a unit does not form any limitation to the unit per se in some case.

The functions described above may be executed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In the context of the present disclosure, the machine readable medium may be a tangible medium, which may include or store a program used by an instruction executing system, apparatus or device or used in conjunction with the foregoing. The machine readable medium may be a machine readable signal medium or a machine readable storage medium. The machine readable medium may include, but is not limited to, an electronic, magnetic, optical, electromagnetic, infrared, semiconductor system, means or device, or any suitable combination of the foregoing. More specific examples of the machine readable storage medium include the following: an electric connection with one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

According to one or more embodiments of the present disclosure, Example One provides a virtual scene processing method, the method comprising:
displaying a video editing interface, wherein the video editing interface comprises at least one scene capturing camera position;
receiving a change trigger operation for the scene capturing camera position, and displaying a virtual scene picture corresponding to the scene capturing camera position;
receiving a picture adjustment operation for the virtual scene picture, adjusting display information of a virtual scene corresponding to the virtual scene picture, and displaying the adjusted virtual scene picture; and
in response to a confirmation trigger operation for the scene capturing camera position, obtaining camera parameters of a virtual camera corresponding to the displayed adjusted virtual scene picture, and associating the camera parameters with the scene capturing camera position.

According to one or more embodiments of the present disclosure, Example Two provides a method of Example One, the method further comprising:
optionally, receiving a picture drag-and-drop operation on the virtual scene picture; and/or
receiving a control trigger operation on a preset direction adjustment control corresponding to the virtual scene picture, wherein the direction adjustment control is used for controlling the virtual scene to move along a preset direction.

According to one or more embodiments of the present disclosure, Example Three provides a method of Example One, wherein after receiving the change trigger operation for the scene capturing camera position, the method further comprises:
optionally, displaying adjustment prompt information, the adjustment prompt information being used for prompting an operation mode for adjusting the virtual scene picture.

According to one or more embodiments of the present disclosure, Example Four provides a method of Example One, wherein the video editing interface comprises a camera position configuration area, the camera position configuration area being used for displaying the scene capturing camera position; and the method further comprises:
optionally, receiving a camera position addition operation, and determining a virtual scene picture corresponding to a scene capturing camera position to be added; and
associating camera parameters of a virtual camera corresponding to the virtual scene picture with the scene capturing camera position, and displaying the scene capturing camera position in the camera position configuration area.

According to one or more embodiments of the present disclosure, Example Five provides a method of Example Four, the method further comprising:
optionally, receiving a camera position addition operation, and displaying, in the camera position configuration area, a scene capturing camera position to be added; and
in response to a picture confirmation operation input for the scene capturing camera position, using a confirmed virtual scene picture as the virtual scene picture corresponding to the scene capturing camera position.

According to one or more embodiments of the present disclosure, Example Six provides a method of Example Four, the method further comprising:
optionally, receiving a camera position addition operation on the virtual scene picture, and determining the virtual scene picture as a virtual scene picture corresponding to a scene capturing camera position to be added.

According to one or more embodiments of the present disclosure, Example Seven provides a method of Example One, the method further comprising:
optionally, receiving a video addition operation for the scene capturing camera position, and associating at least part of information in an added video with the scene capturing camera position.

According to one or more embodiments of the present disclosure, Example Eight provides a method of Example One, the method further comprising:
optionally, updating camera parameters of a virtual camera corresponding to the virtual scene picture based on the picture adjustment operation and the currently displayed virtual scene picture; and
determining display information of the virtual scene based on the updated camera parameters, and determining an adjusted virtual scene picture based on the display information.

According to one or more embodiments of the present disclosure, Example Nine provides a method of Example One, the method further comprising:
optionally, the camera parameters comprising a camera pose and a lens parameter, the lens parameter comprising at least one of a focal length parameter, a frame parameter, and an aperture parameter.

According to one or more embodiments of the present disclosure, Example Ten provides a virtual scene processing apparatus, the apparatus comprising:
an interface display module configured to display a video editing interface, wherein the video editing interface comprises at least one scene capturing camera position;
a picture display module configured to receive a change trigger operation for the scene capturing camera position, and display a virtual scene picture corresponding to the scene capturing camera position;
a picture adjustment module configured to receive a picture adjustment operation for the virtual scene picture, adjust display information of a virtual scene corresponding to the virtual scene picture, and display the adjusted virtual scene picture; and
a camera position confirmation module configured to, in response to a confirmation trigger operation for the scene capturing camera position, obtain camera parameters of a virtual camera corresponding to the displayed adjusted virtual scene picture, and associate the camera parameters with the scene capturing camera position.

The foregoing description merely illustrates the preferable embodiments of the present disclosure and used technical principles. Those skilled in the art should understand that the scope of the present disclosure is not limited to technical solutions formed by specific combinations of the foregoing technical features and also cover other technical solution formed by any combinations of the foregoing or equivalent features without departing from the concept of the present disclosure, such as a technical solution formed by replacing the foregoing features with the technical features disclosed in the present disclosure (but not limited to) with similar functions.

In addition, although various operations are depicted in a particular order, this should not be construed as requiring that these operations be performed in the particular order shown or in a sequential order. In a given environment, multitasking and parallel processing may be advantageous. Likewise, although the above discussion contains several specific implementation details, these should not be construed as limitations on the scope of the present disclosure. Certain features that are described in the context of separate embodiments can also be implemented in combination in a single embodiment. Conversely, various features that are described in the context of a single embodiment can also be implemented in multiple embodiments separately or in any suitable subcombination.

Although the subject matter has been described in language specific to structural features and/or method logical acts, it is to be understood that the subject matter defined in the appended claims is not necessarily limited to the specific features or acts described above. On the contrary, the specific features and acts described above are merely example forms of implementing the claims.

1. A virtual scene processing method, comprising:
displaying a video editing interface, wherein the video editing interface comprises at least one scene capturing camera position;
receiving a change trigger operation for the scene capturing camera position, and displaying a virtual scene picture corresponding to the scene capturing camera position;
receiving a picture adjustment operation for the virtual scene picture, and adjusting display information of a virtual scene corresponding to the virtual scene picture, and displaying the adjusted virtual scene picture; and
in response to a confirmation trigger operation for the scene capturing camera position, obtaining camera parameters of a virtual camera corresponding to the displayed adjusted virtual scene picture, and associating the camera parameters with the scene capturing camera position.

2. The virtual scene processing method of claim 1, wherein receiving the picture adjustment operation for the virtual scene picture and displaying the adjusted virtual scene picture comprises at least one of:
receiving a picture drag-and-drop operation on the virtual scene picture;
receiving a control trigger operation on a preset direction adjustment control corresponding to the virtual scene picture, wherein the direction adjustment control is used for controlling the virtual scene to move along a preset direction.

3. The virtual scene processing method of claim 1, wherein after receiving the change trigger operation for the scene capturing camera position, the method further comprises:
displaying adjustment prompt information, wherein the adjustment prompt information is used for prompting an operation mode for adjusting the virtual scene picture.

4. The virtual scene processing of claim 1, wherein the video editing interface comprises a camera position configuration area, the camera position configuration area being used for displaying the scene capturing camera position; and
the virtual scene processing method further comprises:
receiving a camera position addition operation, and determining a virtual scene picture corresponding to a scene capturing camera position to be added; and
associating camera parameters of a virtual camera corresponding to the virtual scene picture with the scene capturing camera position, and displaying the scene capturing camera position in the camera position configuration area.

5. The virtual scene processing method of claim 4, wherein receiving the camera position addition operation and determining the virtual scene picture corresponding to the scene capturing camera position to be added comprises:
receiving a camera position addition operation, and displaying, in the camera position configuration area, a scene capturing camera position to be added; and
in response to a picture confirmation operation input for the scene capturing camera position, using a confirmed virtual scene picture as the virtual scene picture corresponding to the scene capturing camera position.

6. The virtual scene processing method of claim 4, wherein receiving the camera position addition operation and determining the virtual scene picture corresponding to the scene capturing camera position to be added comprises:
receiving a camera position addition operation on the virtual scene picture, and determining the virtual scene picture as a virtual scene picture corresponding to a scene capturing camera position to be added.

7. The virtual scene processing method of claim 1, further comprising:
receiving a video addition operation for the scene capturing camera position, and associating at least part of information in an added video with the scene capturing camera position.

8. The virtual scene processing method of claim 1, wherein adjusting the display information of the virtual scene corresponding to the virtual scene picture comprises:
updating, based on the picture adjustment operation and the currently displayed virtual scene picture, camera parameters of a virtual camera corresponding to the virtual scene picture; and
determining display information of the virtual scene based on the updated camera parameters, and determining an adjusted virtual scene picture based on the display information.

9. The virtual scene processing method of claim 1, wherein the camera parameters comprise a camera pose and a lens parameter, the lens parameter comprising at least one of a focal length parameter, a frame parameter, and an aperture parameter.

10. (canceled)

11. An electronic device, comprising:
one or more processors;
a storage unit for storing one or more instructions; wherein:
the one or more instructions, when executed by the one or more processors, cause the one or more processors to:
display a video editing interface, wherein the video editing interface comprises at least one scene capturing camera position;
receive a change trigger operation for the scene capturing camera position, and display a virtual scene picture corresponding to the scene capturing camera position;
receive a picture adjustment operation for the virtual scene picture, and adjust display information of a virtual scene corresponding to the virtual scene picture, and display the adjusted virtual scene picture; and
in response to a confirmation trigger operation for the scene capturing camera position, obtain camera parameters of a virtual camera corresponding to the displayed adjusted virtual scene picture, and associate the camera parameters with the scene capturing camera position.

12. The electronic device of claim 11, wherein the instructions to receive the picture adjustment operation for the virtual scene picture and display the adjusted virtual scene picture comprise instructions to perform at least one of:
receive a picture drag-and-drop operation on the virtual scene picture; or
receive a control trigger operation on a preset direction adjustment control corresponding to the virtual scene picture, wherein the direction adjustment control is used for controlling the virtual scene to move along a preset direction.

13. The electronic device of claim 11, wherein after the instructions to receive the change trigger operation for the scene capturing camera position, the instructions further comprise instructions to:
display adjustment prompt information, wherein the adjustment prompt information is used for prompting an operation mode for adjusting the virtual scene picture.

14. The electronic device of claim 11, wherein the video editing interface comprises a camera position configuration area, the camera position configuration area being used for displaying the scene capturing camera position; and
wherein the instructions further comprise instructions to:
receive a camera position addition operation, and determine a virtual scene picture corresponding to a scene capturing camera position to be added; and
associate camera parameters of a virtual camera corresponding to the virtual scene picture with the scene capturing camera position, and display the scene capturing camera position in the camera position configuration area.

15. The electronic device of claim 14, wherein the instructions to receive the camera position addition operation and determine the virtual scene picture corresponding to the scene capturing camera position to be added comprise instructions to:
receive a camera position addition operation, and display, in the camera position configuration area, a scene capturing camera position to be added; and
in response to a picture confirmation operation input for the scene capturing camera position, use a confirmed virtual scene picture as the virtual scene picture corresponding to the scene capturing camera position.

16. The electronic device of claim 14, wherein the instructions to receive the camera position addition operation and determine the virtual scene picture corresponding to the scene capturing camera position to be added comprise instructions to:
receive a camera position addition operation on the virtual scene picture, and determine the virtual scene picture as a virtual scene picture corresponding to a scene capturing camera position to be added.

17. The electronic device of claim 11, wherein the instructions further comprise instructions to:
receive a video addition operation for the scene capturing camera position, and associate at least part of information in an added video with the scene capturing camera position.

18. The electronic device of claim 11, wherein instructions to adjust the display information of the virtual scene corresponding to the virtual scene picture comprise instructions to:
update, based on the picture adjustment operation and the currently displayed virtual scene picture, camera parameters of a virtual camera corresponding to the virtual scene picture; and
determine display information of the virtual scene based on the updated camera parameters, and determine an adjusted virtual scene picture based on the display information.

19. The electronic device of claim 11, wherein the camera parameters comprise a camera pose and a lens parameter, the lens parameter comprising at least one of a focal length parameter, a frame parameter, and an aperture parameter.

20. A non-transitory computer storage medium comprising computer executable instructions which, when executed by a processor, cause the-processor to:
display a video editing interface, wherein the video editing interface comprises at least one scene capturing camera position;
receive a change trigger operation for the scene capturing camera position, and display a virtual scene picture corresponding to the scene capturing camera position:
receive a picture adjustment operation for the virtual scene picture, and adjust display information of a virtual scene corresponding to the virtual scene picture, and display the adjusted virtual scene picture; and
in response to a confirmation trigger operation for the scene capturing camera position, obtain camera parameters of a virtual camera corresponding to the displayed adjusted virtual scene picture, and associate the camera parameters with the scene capturing camera position.

21. The non-transitory computer storage medium of claim 20, wherein the instructions to receive the picture adjustment operation for the virtual scene picture and display the adjusted virtual scene picture comprise instructions to perform at least one of:
receive a picture drag-and-drop operation on the virtual scene picture; or
receive a control trigger operation on a preset direction adjustment control corresponding to the virtual scene picture, wherein the direction adjustment control is used for controlling the virtual scene to move along a preset direction.
